(19) United States
(12) Patent Application Publication
(10) Pub. No.: US 2004/0059591 A1
(43) Pub. Date: Mar. 25, 2004

(54) Method of guidance, a guidance system, eg in a building, and a computer readable medium

(76) Inventor: Hans Greve, Give (DK)

Correspondence Address: Pitney Hardin, Kipp & Szuch, 711 Third Avenue, New York, NY, 10017-4059, US

(21) Appl. No.: 10/415,395

(22) PCT Filed: Oct. 25, 2001
(86) PCT No.: PCT/DK01/00704

(30) Foreign Application Priority Data
Oct. 25, 2000 (DK) PA 2000 01595

(51) Int. Cl. G06F 17/60; G01S 1/00

(52) U.S. Cl. 705/1; 701/300

(57) ABSTRACT

By a method and an arrangement for guidance for instance within a conference centre (1) a number of guidance displays (2-8) are use that are arranged around the conference centre. According to the invention the displays are provided with clear text, e.g. the name of the activity going on in a room as well as an indication of the direction to the room. All the displays are controlled electronically by a central server that will, in case of a change, for instance a change from one room to another, automatically update all displays, whereby the directions will then be caused to guide the conference participant to the place where the activity is now taking place. The central server can partially or completely be an internet server.

The invention relates to a method of guidance, eg within a building, wherein there are provided a number of electronic displays, guidance displays that are configured for displaying information that is received from a server and that comprise guidance for finding one's way around the building; and wherein the server is provided with information about a number of possible paths from first predetermined locations to other predetermined locations.

An arrangement of a corresponding type is known eg from WO 98/00819 that also features a server and a number of electronic displays that indicate directions and are configured for being able to communicate with a handheld unit. If an article number is encoded in the handheld unit, the display is able to display an indication of direction towards the place where the article is to be found. This system is inconvenient if it is to be used eg for guiding a large number of conference participants to a conference hall, where an activity is going on because this prior art arrangement depends on the handheld unit that must at all hours be kept updated by the server. It is inconvenient if all conference participants need to have an updated, handheld unit at their disposal.

WO90/01763 teaches a personnel-guiding system comprising a number of display posts that are arranged in various locations in a building and that are controlled by a computer for being able to display different icons in different colours. When a person follows a particular colour and icon, the person is able to verify whether he/she is on the right track. It is a first drawback of this system that it is necessary to check into the computer that controls the display posts in order for an icon and a colour to be allocated to the user. It is a further drawback that persons may forget the icon or colour allocated to him/her, eg in case he/she gets into a conversation with somebody on the way. It is a third drawback that th display posts do not indicate a direction. If, for instance, the path divides into a T, it is necessary to choose one of the paths and look for a display post to have it confirmed that this is indeed the right path. Finally there is a risk of the icons and colours being misinterpreted due to reflections or other adverse light conditions.

It is the object of the invention to provide a novel method of guidance that is more efficient, versatile and reliable than the known methods.

It is a further object of the invention to provide a method of guidance that involves that all displays can be updated dynamically and expediently in case the guidance is to be modified. It is yet a further object to achieve said advantages without the user needing to invest in and maintaining expensive hardware.

This object is obtained in that the method is exercised such that the server is provided with activity information; and that clear text is shown on the display comprising information about an activity that is associated with the place where the path ends; and that a path is shown by a display being provided at least in those locations where the path may change its direction.

In this manner, for instance a conference participant is guided from one or several entrances of the conference building to the room in which a conference activity takes place, also in case the conference room is, in the last moment, changed from the original one to some place else. This advantage is obtained entirely without the conference participant needing to know the infrastructure of the corridors and flooring of the building, and without it being necessary to check in on a specific location and without all the time having to remember and look for a particular icon or colour, see the above-mentioned prior art.

A further particular advantage of the invention becomes apparent in case of workshops during a conference, where the participants may have to participate in for instance four different workshops. The size of the workshops is typically not known until the very last moment, which means that it is not known which rooms have the right capacity until just before the participants start following the displays to the workshop rooms. According to the invention the guidance can be changed dynamically instantly, whereby the most optimal allocation of rooms and direct guidance to this location can be obtained, for instance by the indication: ‘Workshop activity for sales material’. If this were to be accomplished by the prior art known from WO 90/01763 the participants would all have to initially—in some way or other—be informed which icon, eg a red circle, they were to follow and subsequently it would be necessary to look for display means that display a red circle. According to the invention the path is followed until it divides, and in this place there is a display to indicate the direction and in clear text it says: ‘Workshop activity for sales material’.

The method according to the invention lends itself for use in a wide variety of applications other than the one already mentioned, and therefore it is very versatile. By combining, in accordance with the invention, unequivocal indication of direction with clear text on the displays, it is obtained that the invention can also be used eg for guiding conference participants from the meeting room to the lunch restaurant (it is a well known fact that the restaurants tend to become smaller and more plentiful and that it is often difficult to find the right one). The invention may also comprise guidance to cloakroom or be used for guiding cleaning staff to the rooms to be cleaned and in which particular technical appliances are to be made available. The system according to the invention may also be used to indicate an escape way (as a supplement to an overall safety system) and to indicate the path to a meeting venue that is only to be used by a small number of persons. In case of so-called hot-desking, the invention can also be used to guide a person to his/her office in an office building.

These and many other applications follow from the fact that clear text is used on the displays, where the text and the accompanying directions can readily and expediently be changed.

The use of clear text in connection with the guiding also enables the display of promotions, and the displays can also be configured for graphically displaying particular layouts that characterise eg a conference organiser.

The way through eg a conference centre is defined by path sections in extension of each other, where the path sections are defined between two displays. One display thus shows in the direction of the next display along the path. In addition to indicating the direction to the next display, at least the ongoing activity is shown in clear text. Other information can also be displayed, eg the time during which the activity takes place.

The activity information can be received from a user interface, where an operator reads in information on a conference. The activity information can also be obtained from a booking system that is used in conference centres.

The server is configured such that it is continuously checked whether changes occur and in case there is for instance a change of room, the server will immediately find the new path along the possible paths known to the server. Then information is transmitted to the displays to the effect that the directions are changed while the activity information is maintained.

The information also comprises an arrangement for guidance, for instance in a building, and comprising a number of electronic displays, guidance displays distributed around the building and configured for displaying information received from a server and that comprise directions for finding one's way around the building.

The arrangement is characterised in that a storage is provided for activity information; and that the displays are configured to display at least activity information in clear text and to display directions, which information is received from the server.

The arrangement comprises a number of data storages, for instance a storage with information about possible layouts of the displayed information, and a data storage containing a set of rules of information that is used to define what is to be displayed on the display.

The displays comprise at least a display screen, a data storage and a data processor and, in a preferred embodiment, the data processor is configured for being able to partially control the information that is displayed on the display screen, depending on the information received from the server or depending on no information being received from the server.

In one embodiment of the invention the arrangement comprises a PC that is coupled to a server on the World Wide Web or on an intranet. Such solution provides much easier access to support for the individual application, this support being primarily changes and modifications in the application of the individual user. Since the application of the user is located on a central server, these changes and modifications are also carried out centrally. Additionally, the advantages to the user are that it is not necessary to buy a server for controlling displays. The server can be located anywhere on the internet and the same server can control displays at many different users. This means that the invention is also attractive to less comprehensive guidance display installations.

The invention also relates to a computer readable medium that is configured for containing a data program that comprises control information that is, when run on a computer, configured for being able to control a number of electronic displays that are located along a path to a location, to which an activity is associated such that, at least on such displays that are located where the path may change its direction, directions are displayed as well as further information in clear text about the activity.

The medium can be a CD-ROM, but preferably it is located on a server that can be located anywhere. The precondition for this is that all units are connected to each other via the World Wide Web and/or an intranet. The web-solution also involves that the user does not depend on which control system has been implemented on the PC to be used for updating, since standard internet tools (browser) are used and protocols (TCP/IP and http) in the communication between all units in the applications. The software of the server has the same functionality as mentioned previously, but it is also equipped with a system for limiting the user's access to operating the displays located at this user. Besides, the server defines the scope of the rights of the user to access the configuration and the scope of the rights of access of a system administrator. In this manner many users of the guidance system are able to share the same software, while an administrator carries out maintenance, upgrading and configuration centrally.

In a preferred embodiment, a graphic user interface can be downloaded from the internet and this interface is configured, partly, to update a system of displays, but it is also configured for a user to be able to read in a vast number of data that are to be used by various control programs that can also be downloaded form the internet. The data may comprise eg information on route, information on locations, information on hour, information on activity, promotion, but it may also comprise any other kind of internet information that can be transmitted via the displays and provide the conference participants with information on traffic, etc.

According to one embodiment the computer readable medium can also comprise a booking system that is compatible with the guidance system according to the invention. Thereby versatility and efficiency is further enhanced.

The invention will now be explained in further detail by the following description of exemplary embodiments, reference being made to the drawing, wherein

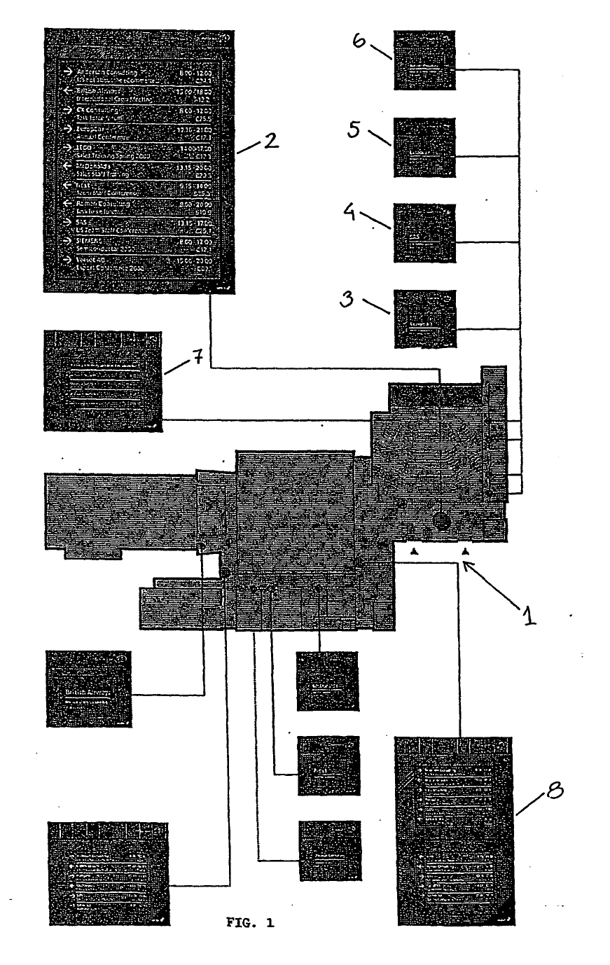

FIG. 1 shows one embodiment of a guidance system according to the invention for guidance within a building;

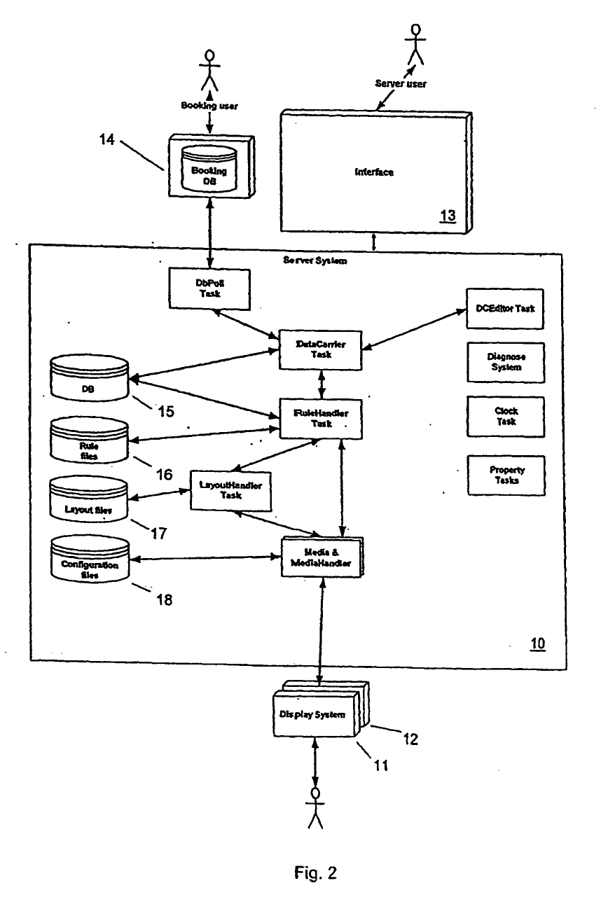

FIG. 2 shows which data units are connected to a preferred embodiment of the invention;

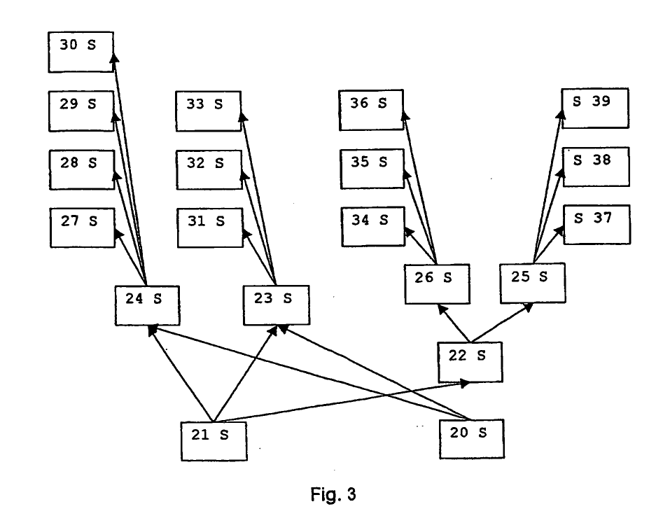

FIG. 3 is an explanatory sketch for understanding the method and mode of operation of the arrangement according to the invention, while

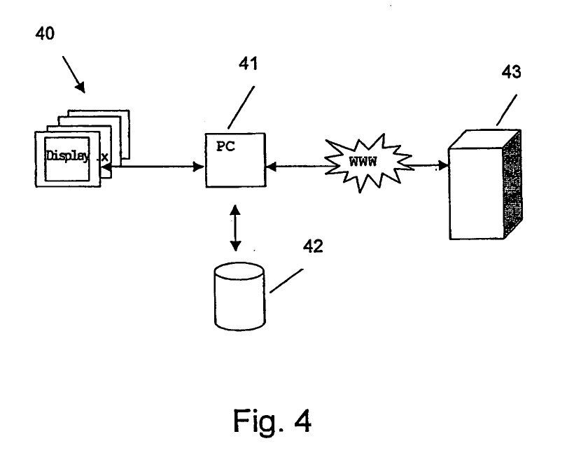

FIG. 4 schematically illustrates a Web-implementation of an embodiment of the invention.

Guidance within a building or a delimited area is conventionally carried out by guidance systems with permanent text. The guidance system is usually organised in a hierarchical system, starting in a few central positions, the entrance of a building or an area wherein survey displays are located, following which the direction of path (reference) spreads like branches on a tree by means of reference displays in order to finally end at the destination by a guidance display that verifies the locality.

The systems are constructed statically and typically show the way to either a specific room, location or a permanent activity. In environments with much conference activity and changing activities or different persons in rooms, such as seminars and conference venues, places of education, hospitals, airports and the like, reference is always made to the name or number of the room. In environments with permanent activities in the rooms and conventional environments where persons need to find their way, of any kind—private as well as public—reference is always made to the activity that goes on in the room. For instance: Administration, Directors, Production, Workout, Tradesmen's entrance, Storage Room, Logistics, etc.

The conventional sign posting and guidance are associated with the obvious drawback that, in environments with much conference activity or in environments with permanent activities, it is a very slow and resource-intensive task to update the guidance displays, if efficient information is to be accomplished. Since the requirement to versatility increases continuously, the need for changes in the display and guidance also demands a continuous increase in resources and efficiency. The known attempts of rationalisation, however, have adversely affected the information quality and the versatility. These drawbacks are remedied by the invention.

FIG. 1 shows an embodiment of the invention used in a conference centre 1. When entering the building by the entrance, one will first see the survey display 2 that will, by means of a description of an activity in clear text and with arrows, point in the direction of the location and hour of that particular activity. If, for instance, one goes to the right, one will arrive at the corridor where the displays 3-6 have been located on the outside of respective doors to some conference rooms. If one takes the left path, one may arrive at the display outside the auditorium or at another display 8 that will, in turn, give indications of directions and activities in clear text, whereby the conference participant is, in this manner, guided to the activity to be pursued.

In this manner the conference participant avoids having to acquaint himself with the location of eg corridor 1, path 4 within the building and avoids having to remember particular colours or icons.

According to the invention dynamic reference is also obtained that reduces the amount of time and resources spent to a minimum, since all updating and changing of the displays are performed electronically from a central server. Besides, only the final destination need to be updated, following which all displays that are constituents of the guidance (reference) to this final destination are automatically updated in correspondence with the invention.

Reference is now made to FIG. 2 that comprises an embodiment of the invention featuring a central server 10 and a number of lectronic displays 11, 12 of the same kind as the one shown in FIG. 1. Such displays may consist of a data storage, a CPU and a display or monitor that is able to display text, pictograms, (arrows and the like) as a minimum. The central server contains software that enables the displays to be updated in accordance with the invention. The embodiment shown in FIG. 2 also comprises a user interface 13 that is used for changing the name and/or activity of the final destination. This can be done in the form of a time-limited change, but also as a change that remains until a new change is entered into the system This user interface can be used directly on the server as well as on a number of workstations that are connected to the same data net as the servers. Alternatively, scheduled activities can be read from a data storage 14 that is a part of a booking system, for instance of the kind known from U.S. Pat. No. 5,634,016. These data from the user interface or the booking system are stored in a database 15 on the server. Thus, this database contains a list of all the variously scheduled activities and changes that are to take place in the future.

Via a ‘DbPoll Task’ the server controls whether changes have occurred relative to the current displays, whether new information has arrived and whether anything has been cancelled. Changes that may occur relative to the current displays and the next to be shown on the displays are subjected to further processing by the server.

In order to enable the system to make a dynamic reference and thus to update all displays that show the way to a given activity or destination, the paths that can be used to find this destination are encoded in the server in the form of ‘Routes’. Such routes are defined by the displays that are provided along the route and by the way in which the reference arrows on these displays are to point in order to show the right way. All of these routes are described and stored in configuration files 18. Such control of the display is accomplished in ‘Rulehandler task’ that determines, via the configuration files, which displays are to be updated and which route is to guide to the destination by means of arrows.

As the displays can be made in different sizes and with different solutions, there is a register 17 of layouts that can be used for the various displays. The register contains a background and location and size of text, graphics and pictograms. Via ‘Layouthandler task’ the final layouts to be shown in the displays are generated.

Finally the display including information about when it is to be shown on the individual displays and when it is to be removed from the display is transmitted. This is accomplished in ‘Media and MediaHandler’ that has, in the configuration files, recorded all the necessary communication parameters for the individual display.

The communication between server and the displays can be performed on a data net. In principle, such net can be any net that is able to transport data from one place to another via cable nets and cordlessly in the form of radio waves, and other media that are capable of carrying data.

In the conventional sign posting, it is necessary to have permanent signs for all localities and/or permanent activities. It is a further drawback of dynamic references that the guidance system shows only the current activities: thereby the overall amount of information is sorted to the user who receives only relevant information.

Reference is now made to FIG. 3 that gives a more detailed example of the mode of operation of the method and the arrangement according to the invention.

The conference centre has two main entrances (20,21), three wings (22,23,24). The wing (22) is in turn divided into two wings (25 and 26). Wing 24 consists of four conference rooms (27,28,29,30). Wing 23 consists of three conference rooms (31,32,33). Wing 26 consists of three conference rooms (34,35,36). Wing 25 consists of three conference rooms (37, 38, 39). The reference ‘S’ is used to designate displays of the kinds shown in FIG. 1, eg pos. 3-6. ‘27S’ is used to designate displays outside room 27.

When the organiser of a conference contacts the Conference facility to book a room, eg room 36, the receptionist enters a registration in the database on the server via his computer to the effect that room 36 is now booked by the organiser on a given date for the given period. In over to have an overview the booking of the rooms, a graphic user interface is provided whose appearance is much like that of a calendar. In this manner it is always possible for the receptionist over have an overall view of which rooms are taken and which are vacant.

In the morning on the date for which the organiser has booked the conference room, the requisite displays are updated such that the conference participants are being guided to the correct meeting. Instead of giving directions to room 36, the text on the displays shows the name of the conference in question and optionally the name of the organiser and an arrow for the point of direction of each display in which the participant is to proceed. At the room where the meeting is to take place, the final display is arranged. Here the name of the meeting can be displayed, optionally the name of the organiser and hour the meeting starts and is expected to be over.

When the participants to the meeting arrive they will, at the entrance to the conference centre, be presented to the display 21S. On this display, the name of the meeting is indicated in clear text and an arrow is shown to the right to indicate the way to display No. 22S. On display 22S the name of the meeting is yet again indicated as well as an arrow to the left that indicates the direction to display 26S. 26S features the same text as well as an arrow straight ahead that indicates the direction to a display 36S that is located at the conference room where the meeting is to be held. As a rule display 36S features a more elaborate text that states name of meeting, name of organiser, optionally the logo of the organiser, and the hour the meeting starts and is expected to be over. Hereby it is confirmed to the participant in the meeting that this is indeed the correct meeting.

In a corresponding manner all other arrangement scheduled for the day in question will be displayed. In this manner, the system automatically ensures that display is performed only of the scheduled events and that the participants who are to participate in these events are pointed in the right direction. By using the name of the event rather than the name of its location, it is made much easier for the participants in the meeting to find his/her way to the meeting, the reference being made directly by the name of the meeting and not by the room in which the meeting takes place.

If it now turns out on the day before or on the morning of the meeting that for some reason or other it is necessary to change the room of the meeting from room 36 to room 30, the entire series of guidance displays is automatically amended to direct the participants to room 30.

Now, when in this situation the participants see display 21S, the arrow will now point to the left towards display 24S instead of to the right towards display 22S. Display 24S will now shown the name of the meeting and a straight arrow to indicate the way to display 30S. The text that was before displayed on sign 36S will now be displayed on display 30S instead. The only thing the receptionist needs to do is to move the booking mark relating to the meeting from room 36 to room 30 on his/her user interface.

A further advantage of the invention will appear from the following example that refers to FIG. 3. Supposing a large conference with many participants is being held in room 37 and that the conference comprises workshops, it is well known that it is not known until the very last moment how many participants sign up for each workshop. As soon as the organisers have ascertained how many participate in each workshop, this information can be transmitted to an op rator who, for instance, reads to the server that there is a need for workshop facilities for 5, 15 and 40 participants, respectively. Now, the server can be configured to find that workshop facilities 39, 35 and 36 have the most optimal size and allocate these workshop facilities to the various activities. This means that within a very short while the guidance display is ready, such that for instance in display No 37S an arrow points in the direction of room 39 with an indication of workshop No. 1. Simultaneously display No. 37S an arrow will point towards the corridor 25 and indicate workshop Nos 2, 3 and 4. The display 25S points in the direction of wing 26 via the display in wing 22, whereby the conference participants are guided directly by displays featuring an indication of direction and an indication of exactly the workshop in which they are to participate.

As the displays may contain both data storage and data processor, it is also possible to display other information than just indications of direction or activity. For instance, there may be a default image or promotion or entirely different information may be displayed.

According to one embodiment of the invention an arrangement for exercising the invention comprises a PC that is configured for receiving queries from the displays and for being able to receive and store control information from a Web server and for transmitting control information to the display. Such embodiment will be described in the following with reference to FIG. 4.

FIG. 4 shows a number of displays 40 at a user who has a PC 41 and optionally an associated hard disk 42. Via conventionally known communication equipment the PC is connected to the World Wide Web (WWW) that comprises a web server 43. Reference being also made to the preceding description of the mode of operation of the system, it is assumed that the user desires to set up an event that is to be displayed on one of the displays 40. Via his PC 41, the user calls the server 43 by means of a standard tool (internet browser) that is installed on the PC 41. In order to enable access to the server 43 the user needs to use a log-in name and password that are recognized by the server.

Then the server 43 transmits the software that is necessary for updating the display system to the PC 41 of the user in the form of a graphic user interface. The user carries out his updates and the server 43 now updates the layouts (images) on the displays on which changes are to take place. These changes in the form of images are now stored on the server 43 or on the hard disk 42 that is located in-house at the user of the application in question. Along with the images, a ‘scheduling file’ is stored for each of the displays that are affected by the changes. All the displays have an independent ‘scheduling file’ that contains information in relation to the individual images in the form of arrows or other as well as information in clear text that is able to display guidance, dates, hours, etc.

Each display functions as an independent ‘user’ on the net that is connected to the PC 41 and each display is configured as a printer or other embedded unit. A unique address is ascribed to the guidance display and it is configured for polling the hard disk 42 or the server 43 for finding the relevant ‘scheduling file’. It is also a part of the configuration how often this polling functionality is to be performed, typically once a minute. If the display finds a ‘scheduling file’ during performance of the polling functionality that is not identical with the one the display already has, the new file is read. In this manner the individual display is updated by means of the information on the hard disk 42 or the server 43. It will be understood that the size and complexity of the individual application influences the balance between what is downloaded from the internet server 43 and what is stored permanently on the hard disk 42. If for instance this is the case of a relatively small installation of displays 40, it will be advantageous to the user to only have to have a PC 41 at his disposal and to be able to download all control programs, user interface, etc., from the internet.

1. A method of guidance, for instance within a building, wherein a number of electronic displays, guidance displays, are located at key points and are configured for displaying clear-text information that is received from a server and for indicating a direction; and wherein the server is provided with information on a number of possible paths from first pre-determined locations to other predetermined locations, characterised in
that the server is provided with information on activity, and
that the information in the server is used for dynamically updating the activity information as well as the directional indication on the displays.

2. A method according to claim 1, characterised in that a path is shown by a display being provided at least on the locations where the path changes direction; and that this display indicates the direction to the next display along said path.

3. A method according to claim 2, characterised in that a path is defined by sections of paths in extension of each other, wherein each section of path is defined between two displays.

4. A method according to claim 1, characterised in that the activity information comprises ia name, location and hours of activity.

5. A method according to claim 4, characterised in that the activity information is received from a user interface.

6. A method according to claim 4 or 5, characterised in that the activity information is received from a booking system.

7. A method according to claims 4-6, characterised in that in all displays along a predetermined path, associated activity information and directions are displayed.

8. A method according to claims 1-7, characterised in that the activity information is polled continuously to detect changes, if any.

9. A method according to claim 8, characterised in that a detected change of location is used for selection of a new path.

10. A method according to claim 9, characterised in that information is transmitted to the displays along the new path to maintain the activity information and optionally to change the directional information.

11. An arrangement for guidance, eg within a building, and wherein a number of electronic displays, guidance displays, are located at key points around the building and are configured for displaying information that is received from a server; and configured to display directional indications for finding one's way around the building; characterised in that a route storage is provided for storing configuration files that define possible routes from first pre-determined locations to other predetermined locations; that a storage for information of activities is provided; and that the guidance displays are configured for at least displaying directional information and activity information in clear text received from the server.

12. An arrangement according to claim 11. characterised in that the arrangement comprises a data storage with information on possible layouts for the guidance display information.

13. An arrangement according to claim 11 or 12, characterised in that the arrangement comprises a data storage for a set of rules of information and comprises means for controlling the displays in response to the activity information and the set of rules.

14. An arrangement according to claims 11-13, characterised in that the guidance displays comprise a display screen, a data storage and a data processor that are configured for controlling the display in response to the information received by the display from the server.

15. An arrangement according to claim 14, characterised in that cables or cordless communication means are provided for transmitting said information.

16. An arrangement according to claim 14 or 15, characterised in that the data processor is configured for displaying predetermined information, eg if the connection to the server is being interrupted.
